(19) United States
(12) Patent Application Publication
(10) Pub. No.: US 2013/0140465 A1
(43) Pub. Date: Jun. 6, 2013

(54) RADIATION IMAGE CAPTURE DEVICE AND RADIATION IMAGE CAPTURE SYSTEM

(71) Applicant: FUJIFILM CORPORATION, Tokyo (JP)

(72) Inventors: Naoyuki NISHINOU, Kanagawa (JP); Yasunori OHTA, Kanagawa (JP)

(73) Assignee: FUJIFILM CORPORATION, Tokyo (JP)

(21) Appl. No.: 13/753,192

(22) Filed: Jan. 29, 2013

Related U.S. Application Data
(63) Continuation of application No. PCT/JP2011/064683, filed on Jun. 27, 2011.

(30) Foreign Application Priority Data
Jul. 30, 2010 (JP) 2010-172792

(51) Int. Cl. G01T 1/20

(52) U.S. Cl. CPC G01T 1/2006
USPC 250/366

(57) ABSTRACT

In a radiation detector (60), pixels with sensor portions (72) that generate electrical charges when irradiated with radiation or light converted from radiation are plurally arrayed two-dimensionally in an imaging region that captures a radiation image, and the radiation detector (60) outputs the electrical charges accumulated in the pixels as electrical signals. A radiation detection section (62), in which sensor portions (146) capable of detecting the radiation or light to which radiation is converted are plurally provided, is provided layered over the imaging region of the radiation detector (60). Thus, a radiation image capture device and radiation image capture system capable of detecting radiation within an imaging region without complicating the structure of an imaging section that captures radiation images are provided.

### CROSS-REFERENCE TO RELATED APPLICATIONS

This application is a continuation application of International Application No. PCT/JP/2011/064683, filed Jun. 27, 2011, which is incorporated herein by reference. Further, this application claims priority from Japanese Patent Application No. 2010-172792, filed Jul. 30, 2010, which is incorporated herein by reference.

### TECHNICAL FIELD

The present invention relates to a radiation image capture device and a radiation image capture system, and particularly relates to a radiation image capture device and radiation image capture system that capture a radiation image expressed by radiation that has been emitted from a radiation source and passed through an imaging subject.

### BACKGROUND ART

In recent years, radiation detectors such as flat panel detectors (FPD) and the like have been realized. In an FPD, a radiation-sensitive layer is disposed on a thin film transistor (TFT) active matrix substrate, and the FPD is capable of converting radiation such as X-rays or the like directly to digital data. A radiation image capture device that uses this radiation detector to capture radiation images expressed by irradiated radiation has been realized. The radiation image capture device that uses this radiation detector has the advantage, over prior art radiation image capture devices that use X-ray films, imaging plates and the like, that images may be checked immediately. This radiation image capture device also has the advantage of being able to perform radioscopic imaging (video imaging) in which radiation images are successively captured.

Diverse types of this kind of radiation detector have been proposed. For example, there are: an indirect conversion system that first converts radiation to light using a scintillator of CsI:Tl, GOS (Gd₂O₂S:Tb) or the like, converts the converted light to electrical charges at sensor portions such as photodiodes or the like, and accumulates these charges; a direct conversion type that converts radiation to electrical charges in a semiconductor layer of amorphous selenium or the like; or the like. Whatever the system, there are a variety of materials that may be used in a semiconductor layer. A radiation image capture device reads out the charges accumulated at the radiation detector in the form of electrical signals, amplifies the read-out electrical signals with amplifier, and then converts the electrical signals to digital data with an analog-to-digital (A/D) converter.

When a radiation image capture device is imaging in a range in which radiation amounts reaching the radiation detector are low, the effects of quantum noise, system noise of the device and the like become more significant because of the decrease in the amounts of arriving radiation, and the signal-to-noise ratio of the image deteriorates. Accordingly, a technology is known, referred to as a “phototimer” or the like, that automatically controls exposure of X-rays (automatic exposure control (AEC)) with the objective of providing the minimum arriving radiation amounts needed to assure a minimum image quality required for image acquisition. Japanese Patent Application Laid-Open (JP-A) No. 2004-251892 discloses a radiation detector in which pixels for radiation image capture and pixels for radiation detection are formed together on a single substrate, in a matrix in a radiation detection region.

### DISCLOSURE OF INVENTION

### Technical Problem

However, in a case in which pixels for radiation image capture and pixels for radiation detection are formed together as in JP-A No. 2004-251892, the structure of the radiation detector is complicated.

The present invention has been made in consideration of the above circumstances, and an object of the present invention is to provide a radiation image capture device and radiation image capture system capable of detecting radiation in an imaging region without the structure of an imaging section that captures radiation images being complicated.

### Solution to Problem

In order to achieve the object described above, a first aspect of the present invention is provided with: an imaging section in which pixels are plurally arranged two-dimensionally in an imaging region that captures a radiation image, each pixel including a first sensor portion that generates electrical charges when irradiated with radiation or with light converted from radiation, and the imaging section outputting electrical charges accumulated at the pixels as an electrical signal; and a detection section that is provided so as to be layered over the imaging region of the imaging section and in which a second sensor portion is plurally provided, the second sensor portion being capable of detecting the radiation or the light converted from radiation.

According to the first aspect of the present invention, in the imaging section, the pixels that include the first sensor portion that generates electrical charges when irradiated with the radiation or when irradiated with light converted from radiation are plurally arranged two-dimensionally in the imaging region that captures a radiation image, and the imaging section outputs electrical charge accumulated at the pixels as an electrical signal. The detection section, in which the second sensor portions capable of detecting the radiation or the light converted from radiation are plurally provided, is provided so as to be layered over the imaging region of the imaging section.

Thus, according to the first aspect of the invention, because the detection section, in which the second sensor portions capable of detecting the radiation or the light converted from radiation are plurally provided, is provided layered over the imaging region of the imaging section, there is no need to form pixels for radiation detection in the imaging section. Therefore, the structure of the imaging portion is not made more complicated, and because the detection section is provided layered over the imaging region of the imaging section, radiation in the imaging region may be detected by the detection section.

According to a second aspect of the present invention, the imaging section may include a conversion layer that converts radiation to light, and the first sensor portion may generate electrical charge when irradiated with the light converted by the conversion layer, and the second sensor portion may be configured to include an inorganic photoelectric conversion material, be disposed at a side of the imaging section at which a face on which the radiation is irradiated is disposed, and detect the light converted by the conversion layer.

A third aspect of the present invention may be further provided with: a generation section that includes an amplifier, a gain amount of the amplifier being alterable and the amplifier amplifying the electrical signals output from the pixels of the detection section, and the generation section generating image data representing a radiation image on the basis of the electrical signals amplified by the amplifier; an irradiation amount detection section that detects an irradiation amount of radiation on the basis of a detection result from the second sensor portions of the detection section; and an adjustment section that adjusts the gain amount of the amplifier on the basis of the radiation irradiation amount detected by the irradiation amount detection section.

A fourth aspect of the present invention may be further provided with an identification section that identifies an imaging subject region of the imaging region at which an imaging subject is disposed, wherein the adjustment section adjusts the gain amount, on the basis of a detection result from the second sensors of the detection section that correspond with the imaging subject region identified by the identification section, such that a main density range of the imaging subject region in the radiation image generated by the generation section is within a predetermined suitable density range.

According to a fifth aspect of the present invention, the generation section may further include an analog-to-digital converter that converts the electrical signals amplified by the amplifier to digital data with a predetermined number of bits, and the adjustment section may adjust the gain amount such that the electrical signals amplified by the amplifier is within an input range that can be converted to digital data with a predetermined resolution at the analog-to-digital converter.

According to a sixth aspect of the present invention, the irradiation amount detection section may further detect, on the basis of a detection result from the second sensor portions of the detection section, at least one of a start of irradiation of radiation or an end of irradiation of radiation.

According to a seventh aspect of the present invention, in a case of radioscopic imaging, the irradiation amount detection section may detect, in an imaging period corresponding to a frame rate of the radioscopic imaging, an irradiation amount of radiation in the imaging period, and the adjustment section may adjust the gain amount of the amplifier on the basis of the irradiation amount of radiation in the imaging period detected by the irradiation amount detection section.

According to an eighth aspect of the present invention, it is preferable if the second sensor portions are disposed at least at a central portion and a peripheral portion of a region corresponding to the imaging region of the imaging section.

According to a ninth aspect of the present invention, the second sensor portions may be disposed in a matrix pattern in the imaging region of the imaging section.

A tenth aspect of the present invention may be further provided with: a simple image generation section that generates a simple radiation image from a detection result from the second sensor portions of the detection section; and a display section that displays the simple radiation image generated by the simple image generation section.

Further, in order to achieve the object described above, an eleventh aspect of the present invention is provided with: an imaging section in which pixels are plurally arranged two-dimensionally in an imaging region that captures a radiation image, each pixel including a first sensor portion that generates electrical charge one of when irradiated with radiation or with light converted from radiation, and the imaging section outputting electrical charge accumulated at the pixels as an electrical signal; and a detection section that is provided so as to be layered over the imaging region of the imaging section and in which a second sensor portion is plurally provided, the second sensor portion being capable of detecting the radiation or the light converted from radiation; a generation section that includes an amplifier, a gain amount of the amplifier being alterable and the amplifier amplifying the electrical signal output from the pixels of the detection section, and the generation section generating image data representing a radiation image on the basis of the electrical signal amplified by the amplifier; an irradiation amount detection section that detects an irradiation amount of radiation on the basis of a detection result from the second sensor portions of the detection section; and an adjustment section that adjusts the gain amount of the amplifier on the basis of the radiation irradiation amount detected by the irradiation amount detection section.

Thus, according to the present invention, because the detection section, in which the second sensor portions capable of detecting radiation or light converted from radiation are plurally provided, is provided so as to be layered over the imaging region of the imaging section, there is no need to form pixels for radiation detection in the imaging section. Therefore, similarly to the first aspect of the invention, the structure of the imaging section is not made more complicated, and because the detection section is provided layered over the imaging region of the imaging section, radiation in the imaging region may be detected by the detection section.

Moreover, the electrical signals outputted from the pixels of the imaging section are amplified by the amplifier, and image data representing a radiation image is generated on the basis of the electrical signals amplified by the amplifier. Because irradiation amounts of radiation are detected on the basis of detection results from the second sensor portions of the detection section, a gain amount of the amplifier may be adjusted on the basis of the detected radiation irradiation amounts, and the radiation image may be adjusted to a suitable density range.

### Advantageous Effects of Invention

According to the present invention, a useful effect is provided in that radiation in an imaging region may be detected without the structure of an imaging section that captures a radiation image being complicated.

### BRIEF DESCRIPTION OF DRAWINGS

FIG. 1 is a block diagram illustrating the structure of a radiology information system in accordance with an exemplary embodiment.

FIG. 2 is a side view showing an example of a state of arrangement of devices in a radiography imaging room of a radiation image capture system in accordance with the exemplary embodiment.

FIG. 3 is a transparent perspective view illustrating internal structure of an electronic cassette in accordance with the exemplary embodiment.

FIG. 4 is a sectional diagram schematically showing a radiation detector and a radiation detection section in accordance with the exemplary embodiment.

FIG. 5 is a sectional diagram showing structure of a thin film transistor and capacitor of the radiation detector in accordance with the exemplary embodiment.

FIG. 6 is a plan view showing structure of a TFT substrate in accordance with the exemplary embodiment.

FIG. 7 is a plan diagram showing a wiring structure of sensor portions of the radiation detection section in accordance with the exemplary embodiment.

FIG. 8 is a block diagram showing principal structures of an electronic system of an electronic cassette in accordance with the exemplary embodiment.

FIG. 9 is an equivalent circuit diagram concerning a single pixel portion of the radiation detector in accordance with the exemplary embodiment.

FIG. 10 is a block diagram showing principal structures of electronic systems of a console and a radiation generation device in accordance with the exemplary embodiment.

FIG. 11 is a flowchart illustrating the flow of processing of an imaging control program in accordance with the exemplary embodiment.

FIG. 12A is a view illustrating an example of a radiation image detected by sensor portions of a radiation detection section.

FIG. 12B is a graph illustrating a cumulative histogram of FIG. 12A.

FIG. 13 is a plan view illustrating the wiring structure of the sensor portions of the radiation detection section in accordance with another embodiment.

FIG. 14A is a graph illustrating changes in digital data values represented by electrical signals output from a sensor portion when radiation is irradiated.

FIG. 14B is a graph illustrating changes in digital data values represented by electrical signals output from a sensor portion when radiation is irradiated.

FIG. 15 is a graph showing changes in an aggregated value when radiation is irradiated.

FIG. 16 is a sectional diagram schematically showing a radiation detector and a radiation detection section in accordance with yet another embodiment.

FIG. 17 is a sectional diagram schematically showing a radiation detector and a radiation detection section in accordance with still another embodiment.

FIG. 18 is a sectional diagram schematically showing a radiation detector and a radiation detection section in accordance with yet another embodiment.

### BEST MODE FOR CARRYING OUT THE INVENTION

Herebelow, modes for carrying out the present invention are described in detail with reference to the attached drawings. Herein, an example is described in which the present invention is applied to a radiation image capture system that captures radiation images using a portable radiation image capture device (hereinafter referred to as an electronic cassette).

First, a configuration of a radiology information system (hereinafter referred to as an RIS) 10 relating to the present exemplary embodiment is described.

The RIS 10 is a system for administering information of clinical appointments, medical records and so forth in a radiology department, and constitutes a portion of a hospital information system (hereinafter referred to as an HIS).

The RIS 10 includes a plural number of imaging request terminal devices (hereinafter referred to as terminal devices) 12, an RIS server 14 and a radiation image capture system (hereinafter referred to as an imaging system) 18, which are connected to a hospital internal network 16 formed with a wired or wireless LAN (local area network) or the like. The imaging system 18 is disposed in individual radiography imaging rooms (or operating rooms) in the hospital. Herein, the RIS 10 constitutes a portion of the HIS provided in the same hospital, and an HIS server (not illustrated) that administers the HIS as a whole is also connected to the hospital internal network 16.

Each terminal device 12 is for a doctor, a radiographer or the like to input and monitor clinical information, facility reservations and the like. Imaging requests for radiographic images, imaging bookings and the like are also conducted through the terminal device 12. The terminal device 12 is constituted to include a personal computer with a display device, and is connected with the RIS server 14 via the hospital internal network 16, enabling communications therebetween.

The RIS server 14 receives imaging requests from the terminal devices 12 and manages an imaging schedule for radiographic images at the imaging system 18. The RIS server 14 is constituted to include a database 14A.

The database 14A contains: information relating to patients, such as information on attributes (name, gender, date of birth, age, blood type, body weight, a patient identification (ID) number and so forth) of each patient (subject of examination), medical history, treatment history, previously imaged radiographic images, and the like; information relating to electronic cassettes 32 of the imaging system 18, such as an identification number (ID information) of each electronic cassette 32 and the type, size, sensitivity, applicable locations of imaging (details of imaging requests that can be handled), the date of first use, the number of uses, and the like; and environmental information representing environments in which the electronic cassettes 32 are used to image radiographic images, which is to say environments in which the electronic cassettes 32 are employed (for example, a radiography imaging room, an operating room and the like).

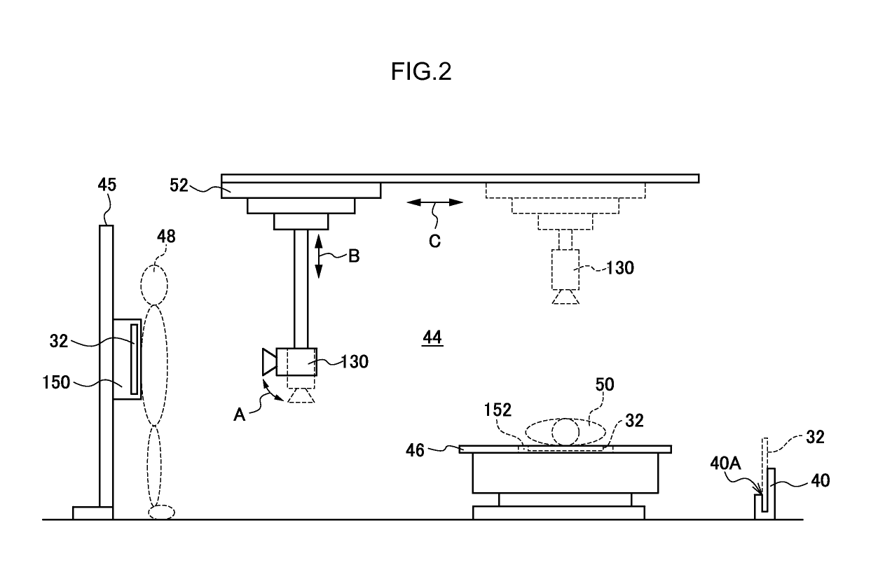

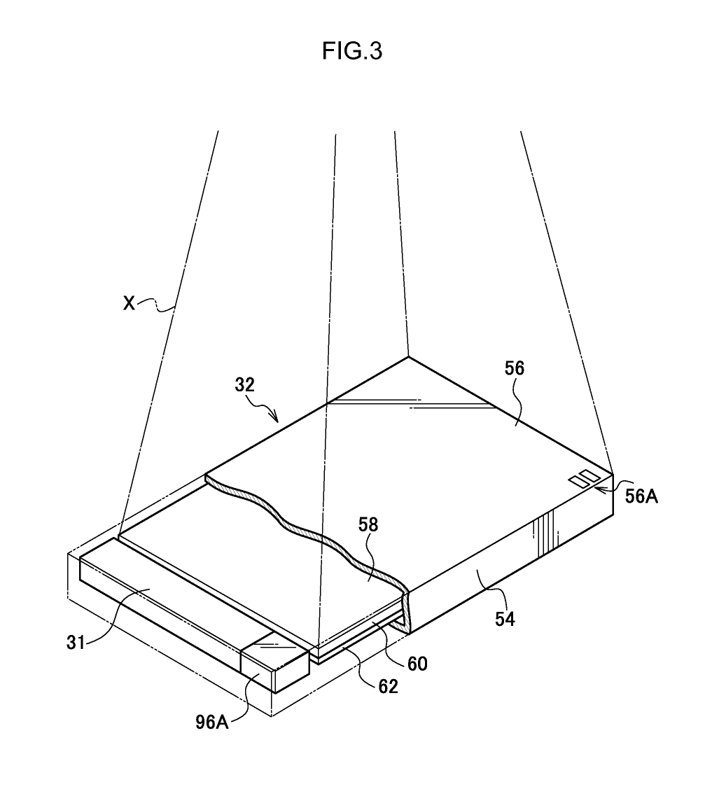

The imaging system 18 carries out imaging of radiographic images in response to instructions from the RIS server 14, in accordance with control by doctors, radiographers and the like. The imaging system 18 is provided with a radiation generation device 34, the electronic cassette 32, a cradle 40, and a console 42. The radiation generation device 34 irradiates radiation X (see FIG. 3), constituted with radiation amounts depending on exposure conditions, from a radiation source 130 (see FIG. 2) at a subject of examination. The electronic cassette 32 incorporates a radiation detector 60 (see FIG. 3) that absorbs radiation X that has passed through an imaging location of the subject of examination and generates electric charges. The cradle 40 charges a battery incorporated in the electronic cassette 32. The console 42 controls the electronic cassette 32, the radiation generation device 34 and the cradle 40.

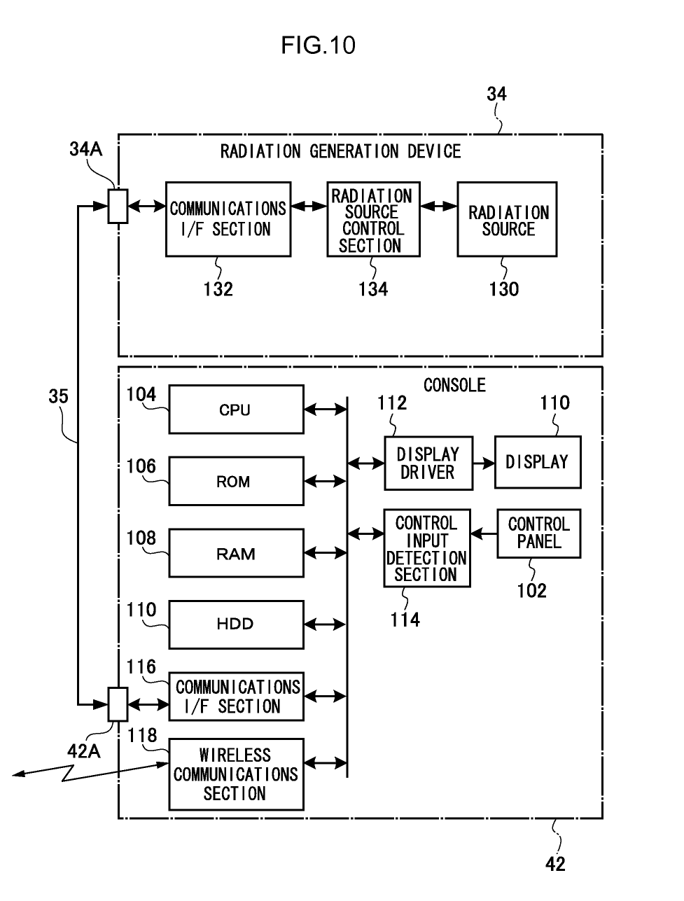

The console 42 acquires various kinds of information contained in the database 14A from the RIS server 14, memorizes the information in an HDD 110 (see FIG. 10), which is described below, and controls the electronic cassette 32, the radiation generation device 34 and the cradle 40 in accordance with this information.

FIG. 2 shows an example of a state of arrangement of devices of the imaging system 18 in accordance with the present exemplary embodiment in a radiography imaging room 44.

As illustrated in FIG. 2, in the radiography imaging room 44, a standing table 45 that is used when a radiation image of an imaging subject in a standing position is being captured and a reclining table 46 that is used when a radiation image of an imaging subject in a reclining position is being captured are provided. A space forward of the standing table 45 serves as an imaging position 48 of the imaging subject when a radiation image is being captured in the standing position, and a space upward of the reclining table 46 serves as an imaging position 50 of the imaging subject when a radiation image is being captured in the reclining position.

A retention portion 150 that retains the electronic cassette 32 is provided at the standing table 45. When a radiation image is being captured in the standing position, the electronic cassette 32 is retained by the retention portion 150. Similarly, a retention portion 152 that retains the electronic cassette 32 is provided at the reclining table 46. When a radiation image is being captured in the reclining position, the electronic cassette 32 is retained by the retention portion 152.

In the radiography imaging room 44, in order that both radiation imaging in the standing position and radiation imaging in the reclining position are possible with radiation from the single radiation source 130, a support and movement mechanism 52 is provided that supports the radiation source 130 to be turnable (in the direction of arrow A in FIG. 2) about a horizontal axis, movable in a vertical direction (the direction of arrow B in FIG. 2) and movable in a horizontal direction (the direction of arrow C in FIG. 2). The support and movement mechanism 52 is provided with each of a drive source that turns the radiation source 130 about the horizontal axis, a drive source that moves the radiation source 130 in the vertical direction and a drive source that moves the radiation source 130 in the horizontal direction (none of which are shown in the drawings).

In the cradle 40, an accommodation portion 40A capable of accommodating the electronic cassette 32 is formed.

When the electronic cassette 32 is accommodated in the accommodation portion 40A of the cradle 40, the battery incorporated in the electronic cassette 32 is charged up. When a radiation image is to be captured, the electronic cassette 32 is taken from the cradle 40 by a radiographer or the like. If the posture for imaging is to be the standing position, the electronic cassette 32 is retained at the retention portion 150 of the standing table 45, and if the posture for imaging is to be the reclining position, the electronic cassette 32 is retained at the retention portion 152 of the reclining table 46.

In the imaging system 18 relating to the present exemplary embodiment, the radiation generation device 34 and the console 42 are connected by respective cables, and various kinds of information are exchanged by communications by wire. The cables connecting the radiation generation device 34 and the console 42 are not shown in FIG. 2. Exchanges of various kinds of information between the electronic cassette 32 and the console 42 are implemented by wireless communications. Note that communications between the radiation generation device 34 and the console 42 may be implemented by wireless communications.

The electronic cassette 32 is not used only in conditions in which it is retained by the retention portion 150 of the standing rack 45 or the retention portion 152 of the reclining rack 46. The electronic cassette 32 is portable, and therefore may be used in conditions in which it is not retained at a retention portion.

FIG. 3 shows internal structure of the electronic cassette 32 according to the present exemplary embodiment.

As shown in FIG. 3, the electronic cassette 32 is provided with a housing 54 formed of a material that transmits the radiation X, and the electronic cassette 32 is structured to be waterproof and tightly sealed. During use in an operating room or the like, blood and saprophytic bacteria and the like may adhere to the electronic cassette 32. Accordingly, the electronic cassette 32, being structured to be waterproof and tightly sealed, is washed with disinfectant as required. Thus, the individual electronic cassettes 32 may be repeatedly used.

Inside the housing 54, the radiation detector 60 and a radiation detection section 62 are arranged in this order from the side of an irradiated surface 56 of the housing 54, onto which the radiation X is irradiated. The radiation detector 60 is for capturing a radiation image according to the radiation X that has passed through an imaging subject. The radiation detection section 62 detects the irradiated radiation.

A case 31 that accommodates electronic circuits, including a microcomputer, and a rechargeable and detachable battery 96A is disposed at one end of the interior of the housing 54. The radiation detector 60 and the electronic circuits are operated by electrical power supplied from the battery 96A provided in the case 31. In order to prevent the various circuits accommodated inside the case 31 from being damaged due to irradiation of the radiation X, it is desirable for lead plating or the like to be provided at the irradiated surface 56 side of the case 31. The electronic cassette 32 according to the present exemplary embodiment has a cuboid shape in which the shape of the irradiated surface 56 is rectangular, and the case 31 is disposed at a portion at one end of the direction of the longest sides thereof.

A display unit 56A is provided at a predetermined location of an exterior wall of the housing 54. The display unit 56A implements displays representing operational states of the electronic cassette 32, including operation modes such as “Ready” and “Receiving data”, the state of a remaining charge amount in the battery 96A, and the like. In the electronic cassette 32 according to the present exemplary embodiment, light emitting diodes are used as the display unit 56A, but this is not a limitation. Other display components may be used, such as light emitting elements other than light emitting diodes, a liquid crystal display, an organic electroluminescent display, or the like.

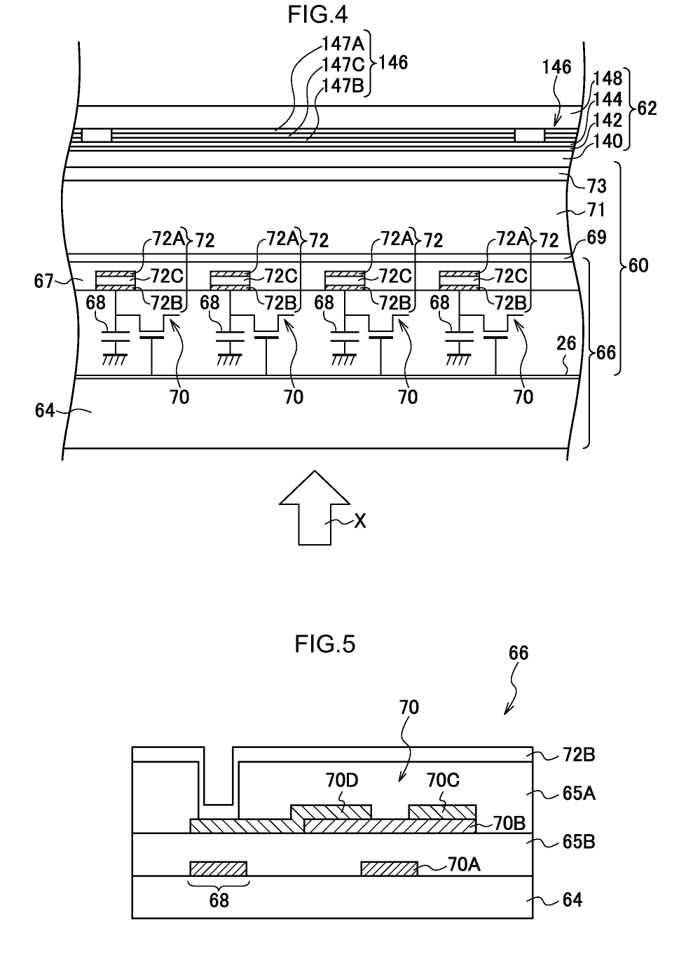

FIG. 4 shows a sectional diagram schematically illustrating structure of the radiation detector 60 and the radiation detection section 62 in accordance with the present exemplary embodiment.

The radiation detector 60 is provided with a TFT active matrix substrate (hereinafter referred to as a TFT substrate) 66 in which thin film transistors (hereinafter referred to as TFTs) 70 and storage capacitors 68 are formed on an insulating substrate 64.

A scintillator 71 that converts incident radiation to light is disposed on the TFT substrate 66.

As the scintillator 71, for example, CsI:Tl or GOS may be used. However, the scintillator 71 is not limited to these materials.

It is sufficient that the insulating substrate 64 features transparency and has a small absorption with respect to the radiation. For example, a glass substrate, a transmissive ceramic substrate or a transparent resin substrate may be used. However, the insulating substrate 64 is not limited to these materials.

Sensor portions 72 that generate electrical charges when the light converted by the scintillator 71 is incident thereon, corresponding to first sensor portions of the present invention, are formed in the TFT substrate 66. A flattening layer 67 for flattening the TFT substrate 66 is also formed in the TFT substrate 66. Between the TFT substrate 66 and the scintillator 71, an adhesion layer 69 for adhering the scintillator 71 to the TFT substrate 66 is formed on the flattening layer 67.

Each sensor portion 72 includes an upper electrode 72A, a lower electrode 72B, and a photoelectric conversion film 72C disposed between the upper and lower electrodes.

The photoelectric conversion film 72C absorbs light emitted from the scintillator 71, and generates electric charges in accordance with the absorbed light. The photoelectric conversion film 72C may be formed of a material that generates electrical charges when illuminated with light, and may be formed of, for example, amorphous silicon, an organic photoelectric conversion material or the like. If the photoelectric conversion film 72C includes amorphous silicon, then the photoelectric conversion film 72C has a broad absorption spectrum and may absorb light emitted by the scintillator 71. If the photoelectric conversion film 72C includes an organic photoelectric conversion material, then the photoelectric conversion film 72C has a sharp absorption spectrum in the visible range and hardly any electromagnetic waves apart from the light emitted by the scintillator 71 are absorbed by the photoelectric conversion film 72C. Thus, noise that is caused by the absorption of radiation such as X-rays and the like at the photoelectric conversion films 72C may be effectively suppressed.

In the present exemplary embodiment, an organic photoelectric conversion material is included in the photoelectric conversion films 72C. Examples of the organic photoelectric conversion material include, for example, quinacridone-based organic compounds and phthalocyanine-based organic compounds. As an example, quinacridone has an absorption peak wavelength of 560 nm, in the visible range. Therefore, if quinacridone is used as the organic photoelectric conversion material, and CsI(Tl) is used as the material of the scintillator 71, a difference between the absorption peak wavelengths may be kept to within 5 nm, and charge amounts generated by the photoelectric conversion films 72C may be substantially maximized. Organic photoelectric conversion materials that may be employed as the photoelectric conversion films 72C are described in detail in JP-A No. 2009-32854, so are not described here.

FIG. 5 schematically shows the structure of each TFT 70 and storage capacitor 68 of the TFT substrate 66 in accordance with the exemplary embodiment.

The storage capacitor 68 and the TFT 70 are formed on the insulating substrate 64, in correspondence with the respective lower electrode 72B. The storage capacitor 68 accumulates electrical charges that migrate to the lower electrode 72B. The TFT 70 converts the electrical charges accumulated in the storage capacitor 68 to electrical signals, and outputs the electrical signals. The region in which the storage capacitor 68 and TFT 70 are formed includes a portion that is superposed with the lower electrode 72B in plan view. Thus, with this structure, the storage capacitor 68 and TFT 70 of each pixel are overlaid with the sensor portion 72 in the thickness direction, and the storage capacitor 68 and TFT 70 and the sensor portion 72 may be disposed in a small area.

At each storage capacitor 68, an insulation film 65A is provided between the insulating substrate 64 and the lower electrode 72B. The storage capacitor 68 is electrically connected to the corresponding lower electrode 72B via wiring of a conductive material that is formed to penetrate through the insulation film 65A. Thus, electrical charges collected on the lower electrode 72B may be allowed to migrate to the storage capacitor 68.

In each TFT 70, a gate electrode 70A, a gate insulation film 65B and an active layer (a channel layer) 70B are layered. A source electrode 70C and a drain electrode 70D are formed, with a predetermined gap formed therebetween, on the active layer 70B. In the radiation detector 60, the active layers 70B are formed of a non-crystalline oxide. The non-crystalline oxide constituting the active layers 70B is preferably an oxide including at least one of indium, gallium and zinc (for example, In—O), is more preferably an oxide including at least two of indium, gallium and zinc (for example, In—Zn—O, In—Ga or Ga—Zn—O), and is particularly preferably an oxide including indium, gallium and zinc. An In—Ga—Zn—O non-crystalline oxide is preferably a non-crystalline oxide whose composition in a crystalline state is represented by InGaO₃(ZnO)ₘ (m being a natural number of less than 6), and is particularly preferably InGaZnO₄.

If the active layers 70B of the TFTs 70 are formed of a non-crystalline oxide, the TFTs 70 do not absorb radiation such as X-rays or the like, or even if they do absorb such radiation, the radiation is only retained in tiny amounts. Therefore, the production of noise may be effectively suppressed.

The non-crystalline oxide that constitutes the active layers 70B of the TFTs 70, the organic photoelectric conversion material that constitutes the photoelectric conversion films 72C, and suchlike can all be formed into films at low temperatures. Therefore, the insulating substrate 64 is not limited to being a substrate with a high thermal resistance such as a semiconductor substrate, a quartz substrate, a glass substrate or the like; a flexible substrate of plastic or the like, or a substrate using aramid or bionanofibers may be used. Specifically, a flexible substrate of a polyester such as polyethylene terephthalate, polybutylene phthalate, polyethylene naphthalate or the like, or a polystyrene, polycarbonate, polyether sulfone, polyarylate, polyimide, polycycloolefin, norbornene resin, poly(chlorotrifluoro ethylene) or the like may be used. If a flexible substrate made of such a plastic is used, weight may be reduced, which is advantageous to, for example, portability and the like. On the insulating substrate 64, the following layers may be provided: an insulating layer for ensuring insulation; a gas barrier layer for preventing permeation of moisture, oxygen and the like; an undercoating layer for improving flatness and contact with the electrodes and the like; and so forth.

With aramid, a heating process up to over 200° C. may be applied. Therefore, a transparent electrode material may be cured at high temperature and resistance may be lowered. Moreover, automatic mounting to a driver chip including a solder reflow step may be applied. Aramid has a thermal expansion coefficient close to that of ITO (indium tin oxide) or a glass substrate or the like. Therefore, there is little curling after fabrication and breakage is unlikely. Aramid may form a thinner substrate than a glass substrate or the like. An ultra-thin glass substrate and aramid may be laminated to form the insulating substrate 64.

A bionanofiber is a combination of cellulose microfibril bundles (microbial cellulose) produced by bacteria (Acetobacter Xylinum) and a transparent resin. The cellulose microfibril bundles have widths of 50 nm, a size that is a tenth of a visible light wavelength, and have high strength, high resilience and low thermal expansion. The microbial cellulose is immersed in a transparent resin such as an acrylic resin, an epoxy resin or the like, and the resin is hardened. Thus, bionanofibers are provided that contain 60-70% fibers and exhibit a transparency of about 90% for a wavelength of 500 nm. The bionanofibers have a low thermal expansion coefficient (3-7 ppm) compared with silicon crystal, have a strength comparable with steel (460 MPa) and a high resilience (30 GPa), and are flexible. Therefore, a thinner insulating substrate 64 may be formed than from a glass substrate or the like.

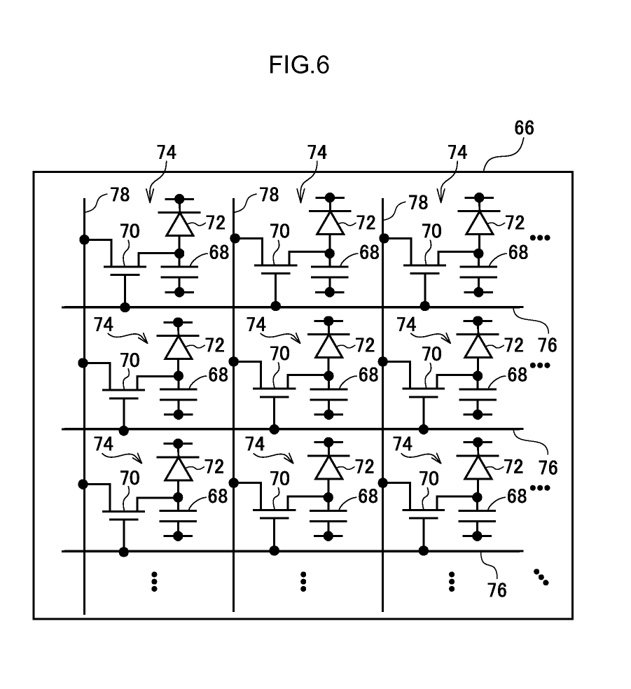

FIG. 6 shows a plan diagram illustrating structure of the TFT substrate 66 in accordance with the exemplary embodiment.

In the TFT substrate 66, pixels 74 that are each structured to include the above-described sensor portion 72, storage capacitor 68 and TFT 70 are plurally provided in a two-dimensional pattern in a certain direction (the row direction in FIG. 6) and a direction crossing the certain direction (the column direction in FIG. 6). For example, if the radiation detection section 62 has a size of 17 inches by 17 inches, the pixels 74 are arranged in 2,880 rows and 2,880 columns.

Plural gate lines 76 and plural data lines 78 are provided in the radiation detector 60. The gate lines 76 extend in the certain direction (the row direction) and are for turning the TFTs 70 on and off. The data lines 78 extend in the direction crossing the gate lines 76 (the column direction) and are for reading out the accumulated electrical charges via the TFTs 70 that have been turned on.

The radiation detector 60 has a flat-plate form, in a quadrilateral shape with four outer edges in plan view. Specifically, the radiation detector 60 is formed in a rectangular shape.

As shown in FIG. 4, the radiation detector 60 in accordance with the present exemplary embodiment is formed by the scintillator 71 being adheringly attached to a surface of the TFT substrate 66.

If the scintillator 71 is formed of, for example, rod crystals such as CsI:Tl or the like, the scintillator 71 is formed by vapor deposition onto a vapor deposition substrate 73. If the scintillator 71 is formed by this vapor deposition, a plate of aluminium is employed as the vapor deposition substrate 73 with regard to transmissivity of X-rays and cost. The vapor deposition substrate 73 must have a certain amount of thickness (of the order of several millimetres) for handling during vapor deposition, avoiding warping due to its own weight, deformation due to radiant heat, and the like.

The radiation detection section 62 is adheringly attached to the face of the radiation detector 60 at the side thereof at which the scintillator 71 is disposed.

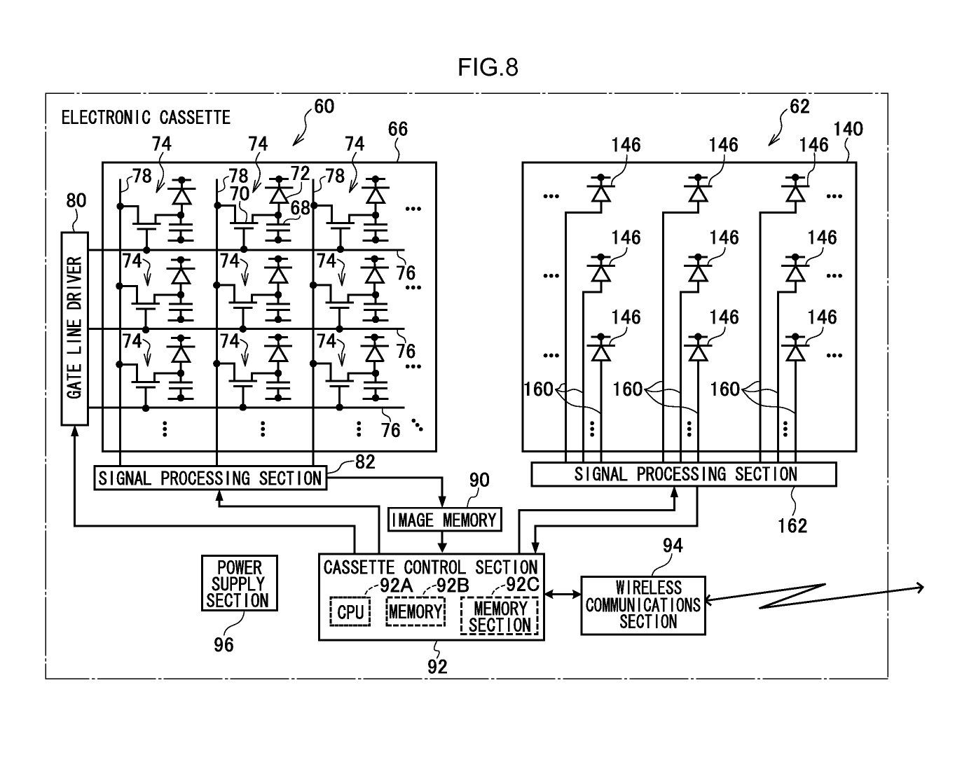

In the radiation detection section 62, as an example, a wiring layer 142 in which wires 160 (FIG. 8) are patterned, which is described below, and an insulation layer 144 are formed on a support substrate 140 made of resin. Plural sensor portions 146, corresponding to second sensor portions of the present invention, are formed thereon. A scintillator 148 formed of GOS or the like is formed over the sensor portions 146 of the radiation detection section 62. Each sensor portion 146 includes an upper electrode 147A, a lower electrode 147B, and a photoelectric conversion film 147C disposed between the upper and lower electrodes. The photoelectric conversion film 147C generates electric charges in response to the incidence of light converted by the scintillator 148. This photoelectric conversion film 147C is preferably a photoelectric conversion film containing the above-described organic photoelectric conversion material, rather than a PIN-type or MIS-type photodiode that uses amorphous silicon. The reason for this is that using a photoelectric conversion film containing an organic photoelectric conversion material is more advantageous in regard to reducing fabrication costs and acquiring flexibility than if a PIN photodiode or an MIS photodiode is used. There is no need for the sensor portions 146 of the radiation detection section 62 to be formed as finely as the sensor portions 72 provided in the pixels 74 of the radiation detector 60; the sensor portions 146 may be larger than the sensor portions 72, and may be formed with a size corresponding to tens or hundreds of the pixels of the radiation detector 60.

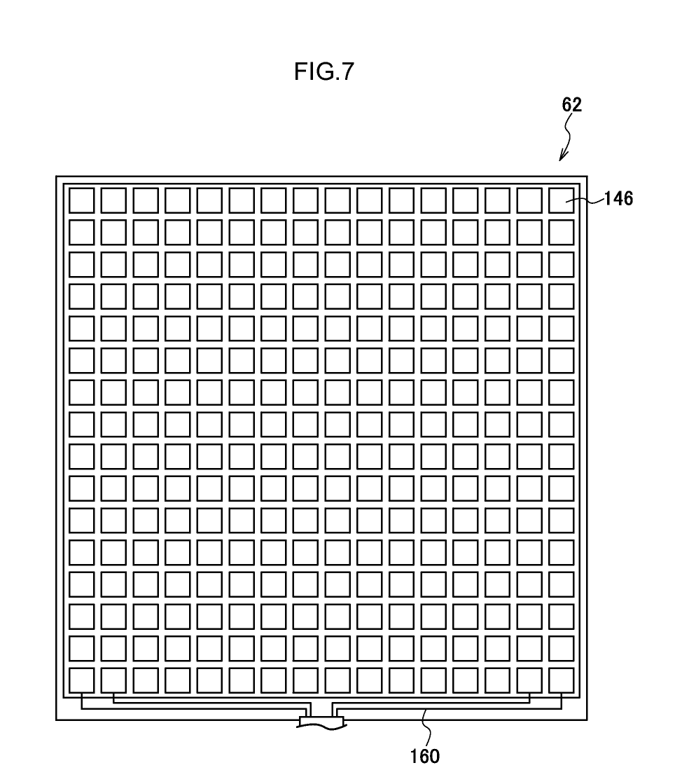

FIG. 7 shows a plan diagram illustrating a wiring structure of the sensor portions 146 of the radiation detection section 62 in accordance with the present exemplary embodiment.

In the radiation detection section 62, the sensor portions 146 are plurally arranged in a certain direction (the row direction of FIG. 7) and a direction crossing the certain direction (the column direction of FIG. 7). For example, the sensor portions 146 are arranged in a matrix of 16 rows and 16 columns.

FIG. 8 shows a block diagram illustrating principal structures of the electronic system of the electronic cassette 32 in accordance with the present exemplary embodiment.

As described above, in the radiation detector 60, the pixels 74 provided with the sensor portions 72, storage capacitors 68 and TFTs 70 are numerously arranged in a matrix. Electrical charges that are generated by the sensor portions 72 in response to irradiation of the radiation X on the electronic cassette 32 are accumulated at the storage capacitors 68 of the individual pixels 74. Thus, the image information carried by the radiation X irradiated onto the electronic cassette 32 is converted to electric charge information and retained in the radiation detector 60.

The individual gate lines 76 of the radiation detector 60 are connected to a gate line driver 80, and the individual data lines 78 are connected to a signal processing section 82. When electrical charges are accumulated at the storage capacitors 68 of the individual pixels 74, the TFTs 70 of the individual pixels 74 are turned on sequentially, row by row, by signals provided through the gate lines 76 from the gate line driver 80. The electrical charges accumulated at the storage capacitors 68 of the pixels 74 whose TFTs 70 have been turned on are propagated through the data lines 78 as analog electrical signals and inputted to the signal processing section 82. Thus, the electrical charges accumulated at the storage capacitors 68 of the individual pixels 74 are sequentially read out in row units.

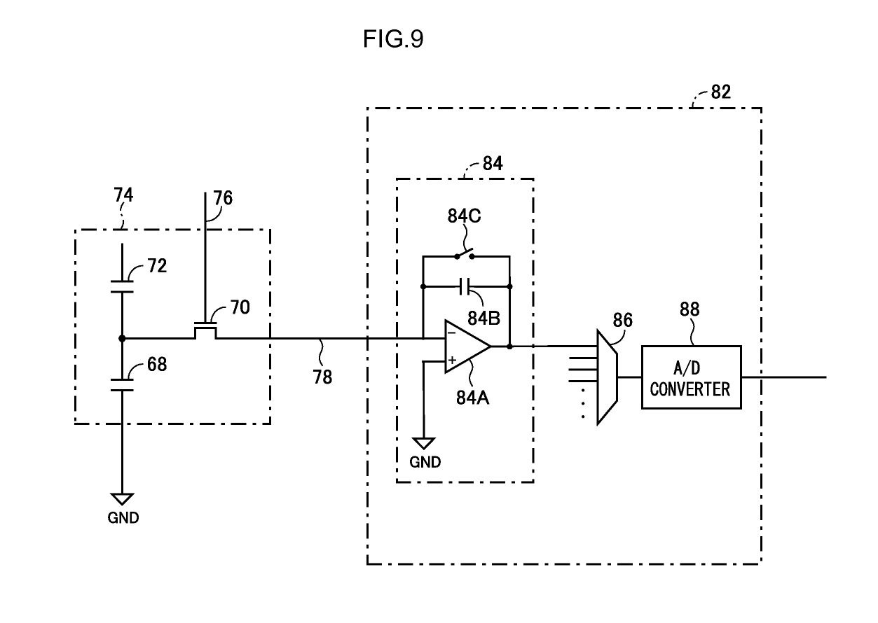

FIG. 9 is an equivalent circuit diagram concerning a single pixel portion of the radiation detector 60 in accordance with the present exemplary embodiment.

As illustrated in FIG. 9, the source of each TFT 70 is connected to the data line 78, and the data line 78 is connected to the signal processing section 82. The drain of the TFT 70 is connected to the storage capacitor 68 and the sensor portion 72, and the gate of the TFT 70 is connected to the gate line 76.

The signal processing section 82 is provided with an individual sample and hold circuit 84 for each data line 78. The electrical signals propagated through the respective data lines 78 are retained at the sample and hold circuits 84. Each sample and hold circuit 84 is constituted to include an operational amplifier 84A and a capacitor 84B, and converts the electrical signals to analog voltages. The sample and hold circuit 84 is further provided with a switch 84C, which serves as a reset circuit that shorts together the two electrodes of the capacitor 84B and discharges electrical charges accumulated on the capacitor 84B. The gain of the operational amplifier 84A is adjustable by control from a cassette control section 92, which is described below.

A multiplexer 86 and an analog-to-digital (A/D) converter 88 are connected, in this order, to the output side of the sample and hold circuits 84. The electrical signals retained by the respective sample and hold circuits are converted to analog voltages, sequentially (serially) inputted into the multiplexer 86, and converted to digital image information by the A/D converter 88.

An image memory 90 is connected to the signal processing section 82 (see FIG. 8). The image data outputted from the A/D converter 88 of the signal processing section 82 is sequentially memorized in the image memory 90. The image memory 90 has a memory capacity capable of memorizing image data corresponding to a plural number of frames. Each time a radiation image is captured, the image data obtained by the imaging is sequentially memorized in the image memory 90.

The image memory 90 is connected with the cassette control section 92, which controls overall operations of the electronic cassette 32. The cassette control section 92 is constituted to include a microcomputer. The cassette control section 92 is provided with a central processing unit (CPU) 92A, a memory 92B including read-only memory (ROM) and random access memory (RAM), and a non-volatile memory section 92C constituted with a hard disc drive (HDD), flash memory or the like.

A wireless communications section 94 is connected to the cassette control section 92. The wireless communications section 94 relating to the present exemplary embodiment complies with wireless LAN (local area network) standards, as typified by IEEE (Institute of Electrical and Electronics Engineers) 802.11a/b/g and the like. The wireless communications section 94 controls transfers of various kinds of information between the cassette control section 92 and external equipment by wireless communications. The cassette control section 92 is capable of wireless communications with the console 42 via the wireless communications section 94, and may exchange various kinds of information with the console 42.

At the radiation detection section 62, as described above, the sensor portions 146 are numerously arranged in a matrix pattern. The plural wires 160 are provided in the radiation detection section 62, and are respectively separately connected to the sensor portions 146. The wires 160 are connected to a signal detection section 162.

The signal detection section 162 is provided with a respective amplifier and A/D converter for each of the wires 160, and is connected to the cassette control section 92. In accordance with control by the cassette control section 92, the signal detection section 162 samples each wire 160 at predetermined intervals, converts electrical signals transmitted through the wires 160 to digital data, and sequentially outputs the converted digital data to the cassette control section 92.

A power supply section 96 is provided in the electronic cassette 32. The various circuits and components described above (the gate line driver 80, the signal processing section 82, the image memory 90, the wireless communications section 94, the cassette control section 92, the signal detection section 162 and so forth) are driven by electrical power supplied from the power supply section 96. The power supply section 96 incorporates the aforementioned battery (a rechargeable secondary cell) 96A so as not to impede portability of the electronic cassette 32, and provides power to the various circuits and elements from the charged battery 96A. Wiring connecting the power supply section 96 with the various circuits and elements is not shown in FIG. 8.

FIG. 10 shows a block diagram illustrating principal structures of electronic systems of the console 42 and the radiation generation device 34 in accordance with the present exemplary embodiment.

The console 42 is configured as a server computer. The console 42 is provided with a display 100, which displays control menus, captured radiographic images and the like, and a control panel 102, which is configured to include plural keys and at which various kinds of information and control instructions are inputted.

The console 42 according to the present exemplary embodiment is provided with: a CPU 104 that administers operations of the device as a whole; a ROM 106 at which various programs, including a control program, and suchlike are memorized in advance; a RAM 108 that temporarily memorizes various kinds of data; the HDD 110, which memorizes and retains various kinds of data; a display driver 112 that controls displays of various kinds of information at the display 100; and a control input detection section 114 that detects control states of the control panel 102. The console 42 is also provided with: a communications interface (I/F) section 116 that exchanges various kinds of information, such as below-described exposure conditions and the like, with the radiation generation device 34 via a connection terminal 42A and a communications cable 35; and a wireless communications section 118 that exchanges various kinds of information, such as exposure conditions, image data and the like, with the electronic cassette 32 by wireless communications.

The CPU 104, the ROM 106, the RAM 108, the HDD 110, the display driver 112, the control input detection section 114, the communications I/F section 116 and the wireless communications section 118 are connected to one another by a system bus. Thus, the CPU 104 may access the ROM 106, the RAM 108 and the HDD 110, and may control displays of various kinds of information at the display 100 via the display driver 112, control exchanges of various kinds of information with the radiation generation device 34 via the communications I/F section 116, and control exchanges of various kinds of information with the radiation generation device 34 via the wireless communications section 118. The CPU 104 may also acquire states of control by users from the control panel 102 via the control input detection section 114.

The radiation generation device 34 is provided with the radiation source 130, a communications I/F section 132, and a radiation source control section 134. The communications I/F section 132 exchanges various kinds of information, such as the exposure conditions and the like, with the console 42. The radiation source control section 134 controls the radiation source 130 on the basis of received exposure conditions.

The radiation source control section 134 includes a microcomputer, and memorizes the received exposure conditions and the like. The exposure conditions received from the console 42 include information such as a tube voltage and a tube current. The radiation source control section 134 causes the radiation X to be irradiated from the radiation source 130 in accordance with the received exposure conditions.

Next, operation of the imaging system 18 relating to the present exemplary embodiment is described.

The imaging system 18 according to the present exemplary embodiment may carry out still image capture, capturing one image at a time, or radioscopic imaging (video imaging), successively capturing images. Still image capture and radioscopic image capture may be selected as imaging modes.

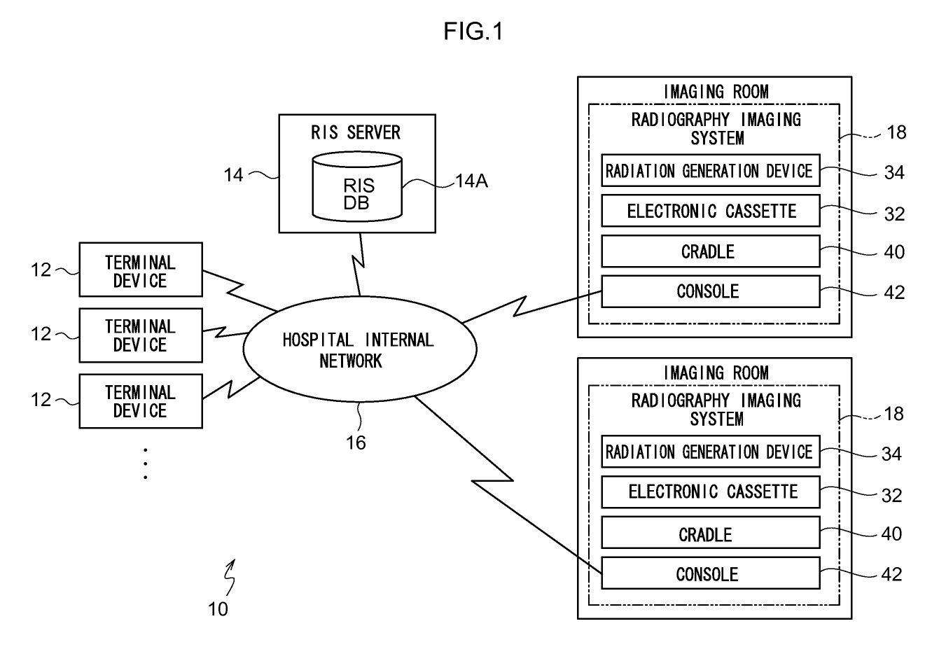

When a radiographic image is to be captured, the terminal device 12 (see FIG. 1) receives an imaging request from a doctor or radiographer. A patient who is the object of imaging, an imaging location that is the object of imaging, and an imaging mode are designated in the imaging request. A tube voltage, tube current and the like are designated as necessary.

The terminal device 12 reports details of the received imaging request to the RIS server 14. The RIS server 14 memorizes the imaging request details reported from the terminal device 12 in the database 14A.

The console 42, by accessing the RIS server 14, acquires the details of the imaging request and attribute information of the patient who is the object of imaging from the RIS server 14, and displays the imaging request details and the patient attribute information at the display 100 (see FIG. 10).

An operator starts the capture of a radiation image in accordance with the imaging request details displayed at the display 100.

For example, as illustrated in FIG. 2, when a patient who is an imaging subject to be imaged is lying down on the reclining table 46, the operator disposes the electronic cassette 32 at the retention portion 152 of the reclining rack 46.

The operator designates still image capture or radioscopic image capture as an imaging mode at the control panel 102, and designates the tube voltage, tube current and the like for when the radiation X is irradiated. In order to suppress irradiation of the imaging subject during radioscopic imaging, the operator designates a lower irradiation amount of radiation per unit time than in a case of capturing a still image (for example, around one tenth of that in a case of capturing a still image).

Now, even in a state in which X-rays are not being irradiated, electrical charges are generated at the sensor portions 72 of the radiation detector 60 by dark currents and the like, and the electrical charges are accumulated at the storage capacitors 68 of the pixels 74.

Therefore, in the electronic cassette 32 according to the present exemplary embodiment, when a radiation image is to be captured, the radiation detection section 62 detects for radiation. When the start of an irradiation of radiation is detected, the electronic cassette 32 carries out a reset operation that reads out and removes the electrical charges accumulated at the storage capacitors 68 of the pixels 74 of the radiation detector 60, and then starts the imaging.

In the imaging system 18 according to the present embodiment, during imaging, the radiation detection section 62 detects radiation amounts irradiated on the electronic cassette 32 and performs X-ray automatic exposure control (AEC) to control the irradiation of radiation from the radiation source 130. Specifically, in a case of still image capture, when a detected radiation amount reaches a permissible amount, the imaging system 18 ends the irradiation of radiation from the radiation source 130 and starts to read out the image from the radiation detector 60. In a case of radioscopic imaging, the imaging system 18 performs successive imaging at a predetermined frame rate, and ends the irradiation of radiation from the radiation source 130 when a radiation amount detected by the radiation detection section 62 reaches a permissible amount. The permissible amount for still image capture is a dose suitable for vividly capturing a radiation image of the imaging location, and the permissible amount for radioscopic imaging is a dose for keeping exposure of the imaging subject within a suitable range, which are respectively different objectives.

Permissible amounts for still image capture and permissible amounts for stereoscopic imaging may be inputted through the control panel 102 by operators at respective times of imaging. Furthermore, still image capture permissible amounts and stereoscopic imaging permissible amounts for respective imaging locations may be memorized in advance in the HDD 110 as imaging location permissible amount information. An operator may designate an imaging location at the control panel 102, and when the imaging location is designated, the imaging system 18 may obtain the permissible amount corresponding to the designated imaging mode and imaging location from the imaging location permissible amount information. Further still, for permissible amounts for stereoscopic imaging, exposure amounts may be memorized by date for each patient in the database 14A of the RIS server 14. The RIS server 14 may calculate an exposure amount permitted for a patient from the total value of exposure amounts in a predetermined period (for example, the preceding three months), and report the permitted exposure amount to the console 42 to serve as the permissible amount.

The console 42 sends the designated tube voltage and tube current to the radiation generation device 34 as exposure conditions, and sends the designated imaging mode, tube voltage, tube current and permissible amount to the electronic cassette 32 as imaging conditions. When the radiation source control section 134 of the radiation generation device 34 receives the exposure conditions from the console 42, the radiation source control section 134 memorizes the received exposure conditions, and when the cassette control section 92 of the electronic cassette 32 receives the imaging conditions from the console 42, the cassette control section 92 memorizes the received imaging conditions in the memory section 92C.

When the operator has completed preparations for imaging, the operator performs an imaging start operation, which instructs imaging, at the control panel 102 of the console 42.

When the imaging start operation is performed at the control panel 102, the console 42 sends instruction information instructing the start of exposure to the radiation generation device 34 and the electronic cassette 32.

The radiation generation device 34 starts the generation and emission of radiation with the tube voltage and tube current according to the exposure conditions received from the console 42.

When the cassette control section 92 of the electronic cassette 32 receives the instruction information instructing the start of exposure, the cassette control section 92 controls imaging in accordance with the imaging mode that has been memorized as an imaging condition in the memory section 92C.

Meanwhile, when a radiation image is to be captured, the electronic cassette 32 according to the present exemplary embodiment detects for radiation with the radiation detection section 62 as described above. The electronic cassette 32 carries out the reset operation when the start of an irradiation of radiation is detected, and then starts imaging. During the imaging, the electronic cassette 32 detects radiation amounts irradiated thereon.

Further, when a radiation image is to be captured, the electronic cassette 32 according to the present exemplary embodiment detects radiation with the radiation detection section 62 and acquires a radiation image for density correction. The electronic cassette 32 analyzes the radiation image for density correction, and finds a gain amount for the operational amplifier 84A to obtain an image with suitable densities. The electronic cassette 32 feeds back the gain amount that is found and adjusts the gain of the operational amplifier 84A and the like, and reads out a radiation image from the radiation detector 60.

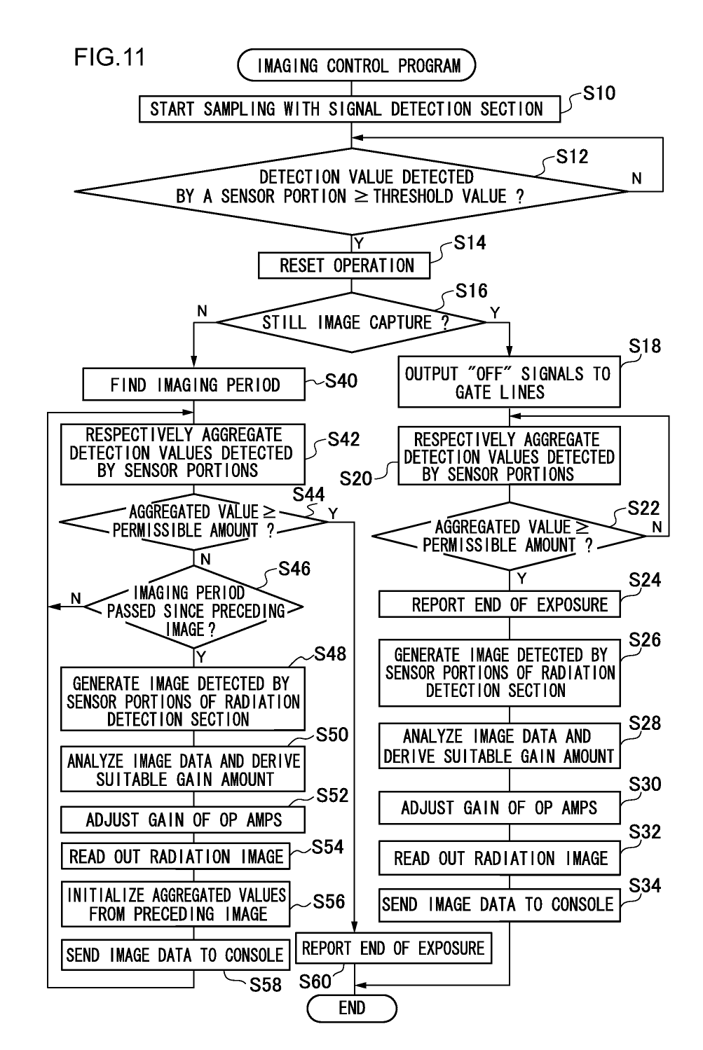

FIG. 11 shows a flowchart illustrating the flow of processing of an imaging control program that is executed by the CPU 92A of the cassette control section 92. This program is memorized in advance in a predetermined region of the memory 92B.

In step S10 of FIG. 11, the cassette control section 92 controls the signal detection section 162 and starts sampling of the wires 160.

Accordingly, the signal detection section 162 samples the wires 160 at predetermined intervals, converts electrical signals propagated through the wires 160 to digital data, and sequentially outputs the converted digital data to the cassette control section 92.

The sensor portions 146 provided at the radiation detection section 62 generate electrical charges when irradiated with the radiation. The generated electrical charges flow into the respective wires 160 in the form of electrical signals.

In step S12, the cassette control section 92 compares values of the digital data detected by the sensor portions 146 that is inputted through the signal detection section 162 with a predetermined threshold value for radiation detection, which has been specified beforehand, and detects for the start of an irradiation of radiation on the basis of whether or not the digital data values are at least the threshold value. If the digital data values are at the threshold value or greater, the cassette control section 92 decides that the irradiation of radiation has started and proceeds to step S14. If the digital data values are less than the threshold value, the cassette control section 92 proceeds to step S12 again, and waits for the start of the irradiation of radiation.

In step S14, the cassette control section 92 controls the gate line driver 80 and causes control signals that turn on the TFTs 70 to be outputted from the gate line driver 80 to the gate lines 76. The cassette control section 92 sequentially turns on the TFTs 70 connected to the respective gate lines 76 one line at a time and extracts the charges. Accordingly, the electrical charges accumulated at the storage capacitors 68 of the pixels 74 sequentially flow out into the respective data lines 78 as electrical signals, one line at a time, and electrical charges that have accumulated at the storage capacitors 68 of the pixels 74 due to dark currents and the like are removed.

In step S16, the cassette control section 92 makes a determination as to whether still image capture is designated as the imaging mode in the imaging conditions memorized in the memory section 92C. If the result of the determination is affirmative, the cassette control section 92 proceeds to step S18, and if the result of the determination is negative (i.e., if radioscopic imaging is designated as the imaging mode), the cassette control section 92 proceeds to step S40.

In step S18, the cassette control section 92 controls the gate line driver 80 and causes control signals that turn off the TFTs 70 to be outputted from the gate line driver 80 to the gate lines 76.

In step S20, the cassette control section 92 corrects values of digital data detected by the sensor portions 146 that is inputted through the signal detection section 162, in accordance with sensitivities of the sensor portions 146, and aggregates respective corrected values for each of the sensor portions 146. These aggregated values may be treated as irradiated radiation amounts.

In step S22, the cassette control section 92 makes a determination as to whether the aggregated value of any of the sensor portions 146 is at least the permissible amount. If the result of this determination is affirmative, the cassette control section 92 proceeds to step S24, and if the result of the determination is negative, the cassette control section 92 proceeds to step S20.

In step S24, the cassette control section 92 sends instruction information instructing the end of exposure to the console 42.

When the console 42 receives the instruction information instructing the end of exposure from the electronic cassette 32, the console 42 sends instruction information instructing the end of exposure to the radiation generation device 34. When the radiation generation device 34 receives the instruction information instructing the end of exposure, the radiation generation device 34 stops the irradiation of radiation.

In step S26, the cassette control section 92 arranges the aggregated values of the sensor portions 146 provided at the radiation detection section 62 in a two-dimensional pattern corresponding with the arrangement of the sensor portions 146. Thus, the cassette control section 92 generates image data of a simple radiation image detected by the sensor portions 146 of the radiation detection section 62, using the aggregated values as pixel values. The sensor portions 146 of the radiation detection section 62 are formed with a size corresponding to tens or hundreds of the pixels of the radiation detector 60. Thus, this simple radiation image is a thinned image of the radiation image to be captured by the radiation detector 60.

In step S28, the cassette control section 92 analyzes the image data generated in step S26, and derives a suitable gain amount for the operational amplifier 84A.

This analysis of the image is now described.

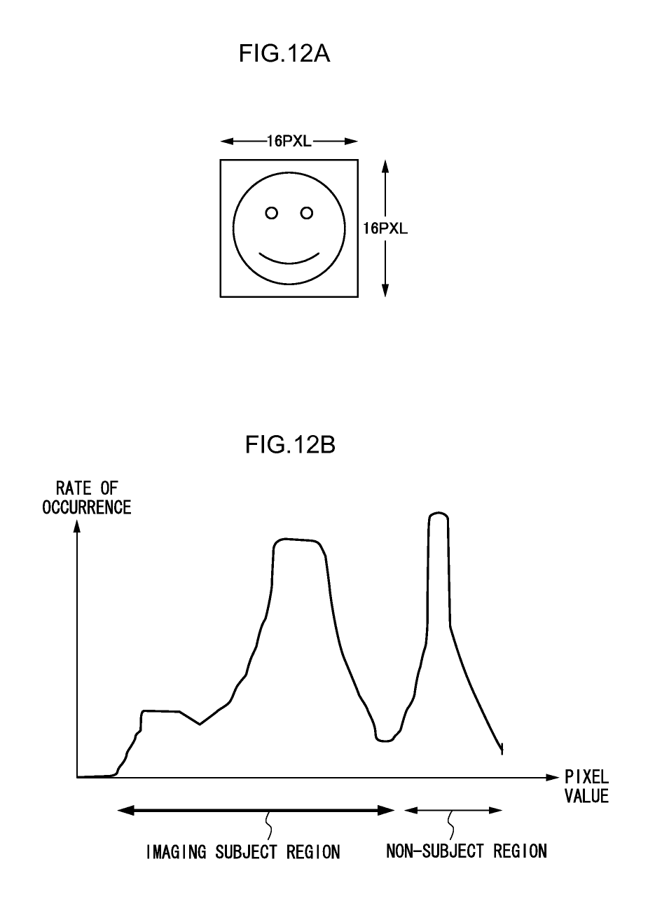

FIG. 12A shows an example of a radiation image detected by the sensor portions 146 of the radiation detection section 62. FIG. 12B illustrates a cumulative histogram of the radiation image shown in FIG. 12A. The meaning of the term “cumulative histogram” as used herein includes a graph of all image data constituting a single radiation image, with pixel values along the horizontal axis and rates of occurrence (frequencies) of pixels with those pixel values along the vertical axis.

The radiation image has large numbers of pixels in an imaging subject region representing a view of an imaging location (a face in FIG. 12A) and in a region not representing the imaging location, which is referred to as a non-subject region. Accordingly, in the cumulative histogram, there are peaks in the cumulative values for the imaging subject region and the non-subject region. Because the imaging subject region has greater density variations, the imaging subject region has a greater width in the cumulative histogram.

In this cumulative histogram, a range of data values according to the view of the imaging location is identified. As a method for this identification, a well-known technology may be used. In the present exemplary embodiment, active contour extraction processing such as a snake algorithm or the like or outline extraction processing using a Hough transform or the like is carried out, and a region enclosed by lines along contour points is identified as the imaging subject region. For example, the imaging subject region may be identified using the technology recited in JP-A No. 4-11242. As a further example, pattern images representing standard shapes for respective imaging locations may be memorized in the memory 92B. Pattern matching may be performed by varying the position, magnification and the like of a pattern image corresponding to the imaging location in the captured radiation image and calculating levels of similarity between the radiation image and the pattern image. A region with the highest frequencies could be identified as the imaging subject region. Further, the imaging subject region may be designated by a radiographer at the console 42 or the like. Further the electronic cassette 32 may receive information representing the imaging subject region from the console 42 and identify the imaging subject region on the basis of the received information.

Thus, the cassette control section 92 finds a cumulative histogram of the identified imaging subject region of the radiation image. The cassette control section 92 uses, for example, a range of the cumulative histogram in which the values are at least a predetermined proportion of a peak value (for example a half-value range) as a main density range of the imaging subject region, and finds a gain amount of the operational amplifier 84A such that the middle of this density range is at the middle of a predetermined suitable density range. For the gain amount, the cassette control section 92 may pre-memorize suitable gain amounts for respective differences between the middle of the density range and the middle of the suitable density range in the memory 92B (the ROM) as gain amount information, and find a gain amount corresponding to a difference between the middle of the density range and the middle of the suitable density range from the gain amount information. Alternatively, a computation expression defining a relationship between distances between the middle of the density range and the middle of the suitable density range and suitable gain amounts may be memorized in the memory 92B (the ROM), and the cassette control section 92 may calculate a gain amount from the distance between the middle of the density range and the middle of the suitable density range with the computation expression.

Next, in step S30, the cassette control section 92 adjusts the gains of the operational amplifier 84A to the gain amount derived in step S28.

In step S32, the cassette control section 92 controls the gate line driver 80 and causes “on” signals to be sequentially outputted from the gate line driver 80 to the gate lines 76 one line at a time.

When the radiation detector 60 turns on the TFTs 70 connected to the gate lines 76 line by line, the electrical charges accumulated at the storage capacitors 68 flow out into the respective data lines 78 as electrical signals, line by line. The electrical signals flowing into the data lines 78 are amplified by the operational amplifier 84A of the signal processing section 82, and are then sequentially inputted to the A/D converter 88 via the multiplexer 86, converted to digital image data, and memorized in the image memory 90.

Thus, the cassette control section 92 adjusts the gains of the operational amplifier 84A and reads out the radiation image from the radiation detector 60. Therefore, the density range of an imaging subject region of the radiation image that is read out may be set to a suitable density range.

In step S34, the cassette control section 92 sends the image data memorized in the image memory 90 to the console 42, and the processing ends.

Alternatively, in step S40, the cassette control section 92 finds an imaging period corresponding to the frame rate of the stereoscopic imaging.

In step S42, the cassette control section 92 corrects the values of digital data detected by the sensor portions 146 inputted through the signal detection section 162, in accordance with sensitivities of the sensor portions 146, and aggregates respective corrected values for each of the sensor portions 146. In the present exemplary embodiment, two memory regions for memorizing the aggregated values of the digital data are reserved for the respective sensor portions 146. One of the memory regions is a memory region that memorizes the aggregated values of the digital data from the start of imaging of the radioscopic images, and the other memory region is a memory region that memorizes the aggregated values of the digital data from a preceding image of the successive images of the stereoscopic imaging. In this step S42, the digital data values for the respective sensor portions 146 are respectively aggregated in the two memory regions.

In step S44, the cassette control section 92 makes a determination as to whether the aggregated value memorized for any of the sensor portions 146 in the memory region that memorizes the aggregated value of digital data from the start of imaging of the radioscopic images is at least the permissible value. If the result of this determination is affirmative, the cassette control section 92 proceeds to step S60, and if the result of the determination is negative, the cassette control section 92 proceeds to step S46.

In step S46, the cassette control section 92 makes a determination as to whether an interval of at least the imaging period has passed since the readout of electrical charges from the pixels 74 of the radiation detector 60. If the result of this determination is affirmative, the cassette control section 92 proceeds to step S48, and if the result of the determination is negative, the cassette control section 92 proceeds to step S42.

In step S48, the cassette control section 92 arranges the aggregated values of the sensor portions 146 provided at the radiation detection section 62 that have been memorized in the memory region that memorizes the aggregated values of digital data from the preceding image in a two-dimensional pattern corresponding with the arrangement of the sensor portions 146. Thus, the cassette control section 92 generates image data of a radiation image detected by the sensor portions 146 of the radiation detection section 62, using the aggregated values as pixel values.

In step S50, similarly to step S28 described above, the cassette control section 92 analyzes the image data generated in step S48 and derives a suitable gain amount for the operational amplifier 84A.

In step S52, the cassette control section 92 adjusts the gains of the operational amplifier 84A to the gain derived in step S50.

In step S54, the cassette control section 92 controls the gate line driver 80 and causes “on” signals to be sequentially outputted from the gate line driver 80 to the gate lines 76 one line at a time.

Thus, the radiation detector 60 turns on the TFTs 70 connected to the gate lines 76 line by line, and the electrical charges accumulated at the storage capacitors 68 flow out into the respective data lines 78 as electrical signals, line by line. The electrical signals flowing into the data lines 78 are amplified by the operational amplifier 84A of the signal processing section 82, and are then sequentially inputted to the A/D converter 88 via the multiplexer 86, converted to digital image data, and memorized in the image memory 90.

Thus, the cassette control section 92 adjusts the gains of the operational amplifier 84A and reads out the radiation image from the radiation detector 60. Therefore, the density range of an imaging subject region of the radiation image that is read out may be set to a suitable density range.

In step S56, the cassette control section 92 initializes all the aggregated values memorized in the memory region that memorizes the aggregated values of digital data from the preceding image, of the two memory regions that memorize the aggregated values of digital data for the respective sensor portions 146, to zero.

In step S58, the cassette control section 92 sends the image data memorized in the image memory 90 to the console 42 and, after sending the image data, proceeds to step S42.

Alternatively, in step S60, the cassette control section 92 sends instruction information instructing the end of exposure to the console 42, and the processing ends.

When the radiation generation device 34 receives the instruction information instructing the end of exposure, the radiation generation device 34 ends the generation and emission of radiation. In the present exemplary embodiment, a case is described in which the radioscopic imaging stops if the aggregated value of any sensor portion 146 reaches the permissible value during radioscopic imaging. However, the fact that the permissible amount has been exceeded may be reported to the console 42 and a warning displayed at the console 42. Further, the console 42 may send exposure conditions in which one or both of the tube voltage and the tube current is reduced to the radiation generation device 34, and the radiation amount per unit time that is irradiated from the radiation source 130 of the radiation generation device 34 may be reduced.

When the console 42 receives the image information from the electronic cassette 32, image processing to perform various kinds of correction, such as shading correction and the like, is applied to the received image information, and the image-processed image information is memorized in the HDD 110.

The image information memorized in the HDD 110 is displayed at the display 100, for checking of the captured radiation image and the like, and is transferred to the RIS server 14 and saved into the database 14A. Hence, a doctor may carry out diagnostics, screening or the like of the captured radiation image.

The aggregated values of the digital data values detected by the sensor portions 146 may be treated as exposure amounts of the imaging subject. Therefore, if exposure values are being memorized by date for each patient, the electronic cassette 32 sends the aggregated values to the RIS server 14 via the console 42 and the aggregated values are memorized in the database 14A.

As described above, according to the present exemplary embodiment, the radiation detection section 62 in which the sensor portions 146 capable of detecting radiation are plurally provided is disposed to be layered over the imaging region of the radiation detector 60. Thus, there is no need to form pixels for radiation detection in the radiation detector 60. Therefore, the structure of the radiation detector 60 is not made complicated. Moreover, because the radiation detection section 62 is provided layered over the imaging region of the radiation detector 60, radiation in the imaging region may be detected by the radiation detection section 62. According to the present exemplary embodiment, pixels or sensors for radiation detection are not provided in the radiation detector 60. Therefore, there is no need to perform interpolation processing of pixels for radiation detection in a captured radiation image. Furthermore, positions at which radiation is detected may be varied in accordance with positions when the radiation detector 60 is provided layered over the radiation detector 60, and AEC may be applied at arbitrary locations.

Further, according to the present exemplary embodiment, an image of an imaging subject region may be adjusted to a suitable density range without saturation at the A/D converter 88, by adjusting the gain amounts of the operational amplifier 84A in accordance with an image obtained from detection results by the sensor portions 146 of the radiation detection section 62.

According to the present exemplary embodiment, detections of the start of an irradiation of radiation and of radiation amounts of the radiation may be carried out in parallel by the sensor portions 146 of the radiation detection section 62.

According to the present exemplary embodiment, there is no need to accelerate the imaging period in order to acquire an image for density correction. Therefore, even if, for example, it is necessary to continuously acquire images for density correction because a region of interest changes during radioscopic imaging and it is necessary to continuously carry out density correction, there is no need to increase the frame rate.

The present invention has been described using an exemplary embodiment hereabove, but the technical scope of the present invention is not to be limited to the scope recited in the above exemplary embodiment. Numerous modifications and improvements may be applied to the above exemplary embodiment within a scope not departing from the spirit of the present invention, and modes to which these modifications and/or improvements are applied are to be encompassed by the technical scope of the invention.

Furthermore, the exemplary embodiment described above is not to limit the inventions relating to the claims, and means for achieving the invention are not necessarily to be limited to all of the combination of features described in the exemplary embodiment. Various stages of the invention are included in the above exemplary embodiment, and various inventions may be derived by suitable combinations of the plural structural elements that are disclosed. If some structural element is omitted from the totality of structural elements illustrated in the exemplary embodiment, as long as the effect thereof is provided, a configuration from which the some structural element is omitted may be derived to serve as the invention.

For example, in the exemplary embodiment described above, a case is described in which the present invention is applied to the electronic cassette 32 that is a portable radiation imaging device. However, the present invention is not limited thus. The present invention may be applied to a stationary type of radiation imaging device.

Further, in the exemplary embodiment described above, a case is described in which the gain of the operational amplifier 84A is adjusted such that the main density range of an imaging subject region of a radiation image captured by the radiation detector 60 is at a suitable density range. However, the present invention is not limited thus. The electrical signals output to the data lines 78 of the radiation detector 60 as described above are amplified by the operational amplifier 84A of the signal processing section 82 and then converted to digital data by the A/D converter 88. Here, the A/D converter 88 sets an input range that may convert inputs to digital data with a predetermined resolution. Electrical signals exceeding the input range are saturated and, for example, uniformly converted to a maximum value. Accordingly, the gain amounts may be adjusted such that the electrical signals that have been amplified by the operational amplifier 84A are within the input range of the A/D converter 88. The aggregated values of the digital data detected by the sensor portions 146 of the radiation detection section 62 may be treated as irradiated radiation amounts. Therefore, in the case of the exemplary embodiment described above, for example, suitable gain amounts may be pre-memorized as gain amount information for respective aggregated values, a maximum value of aggregated values of the sensor portions 146 of the radiation detection section 62 may be found, and the gain amount corresponding to the maximum value found from the gain amount information.

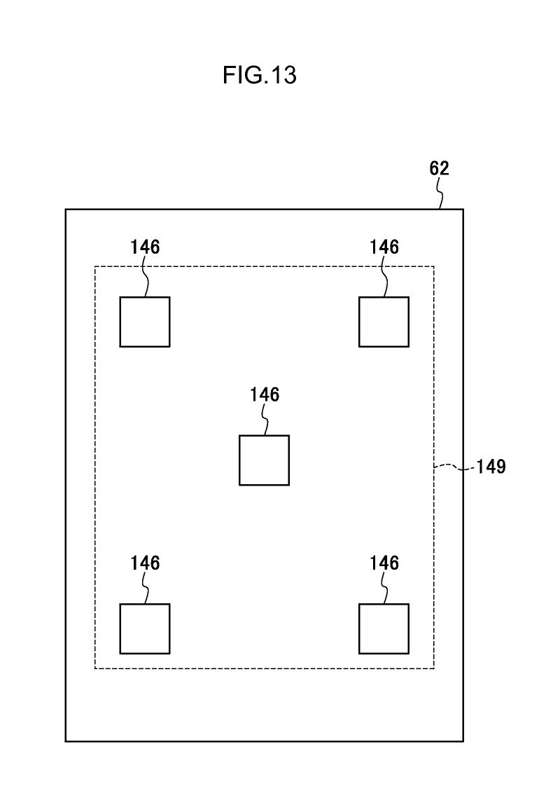

In the exemplary embodiment described above, a case is described in which the sensor portions 146 are arranged at the radiation detection section 62 in a matrix pattern, but the present invention is not limited thus. For example, as illustrated in FIG. 13, the sensor portions 146 may be disposed at a central portion and peripheral portions (four corner portions in FIG. 13) of a region 149 that corresponds to the imaging region of the radiation detection section 62.

In the exemplary embodiment described above, a case is described in which the sensor portions 146 have the same size, but the present invention is not limited thus. For example, plural types of the sensor portions 146 with different sizes may be provided at the radiation detection section 62.

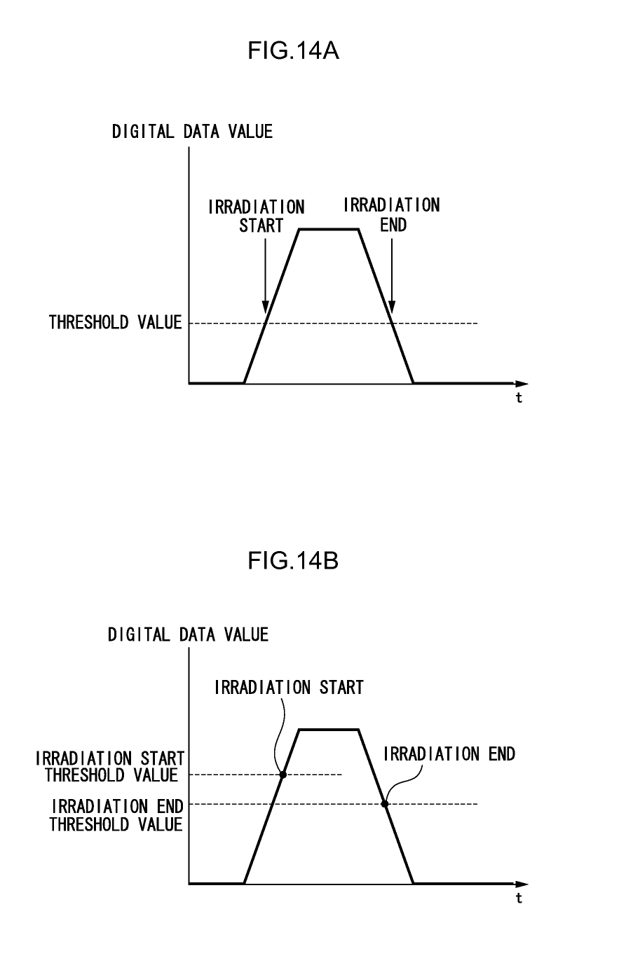

In the exemplary embodiment described above, a case is described in which the start of an irradiation of radiation and radiation amounts of the radiation are detected, but the present invention is not limited thus. For example, the end of an irradiation of radiation may be detected. As illustrated in FIG. 14A, digital data values from the sensor portions 146 inputted through the signal detection section 162 may be compared with a predetermined threshold value for radiation detection that is specified in advance, and the end of an irradiation of radiation may be detected in accordance with whether or not the digital data values are less than the threshold value. As illustrated in FIG. 14B, the threshold values for detection of the start of an irradiation and the end of an irradiation may be made different. In FIG. 14B, the irradiation start threshold value is set larger than the irradiation end threshold value. However, the irradiation start threshold value may be set smaller than the irradiation end threshold value. Irradiation starts and irradiation ends may be detected with the effects of noise and the like being suppressed by the application of hysteresis to the detections of irradiation starts and irradiation ends. For example, electrical charges are generated in the sensor portions 146 by an irradiation being irradiated, a portion of the electrical charges generated in the sensor portions 146 are temporarily trapped and, after the end of the irradiation of radiation, the trapped electrical charges flow from the sensor portions 146 into the wires 160 as electrical charges. In such a case, the end of an irradiation may be detected promptly by the irradiation end threshold value being made larger.

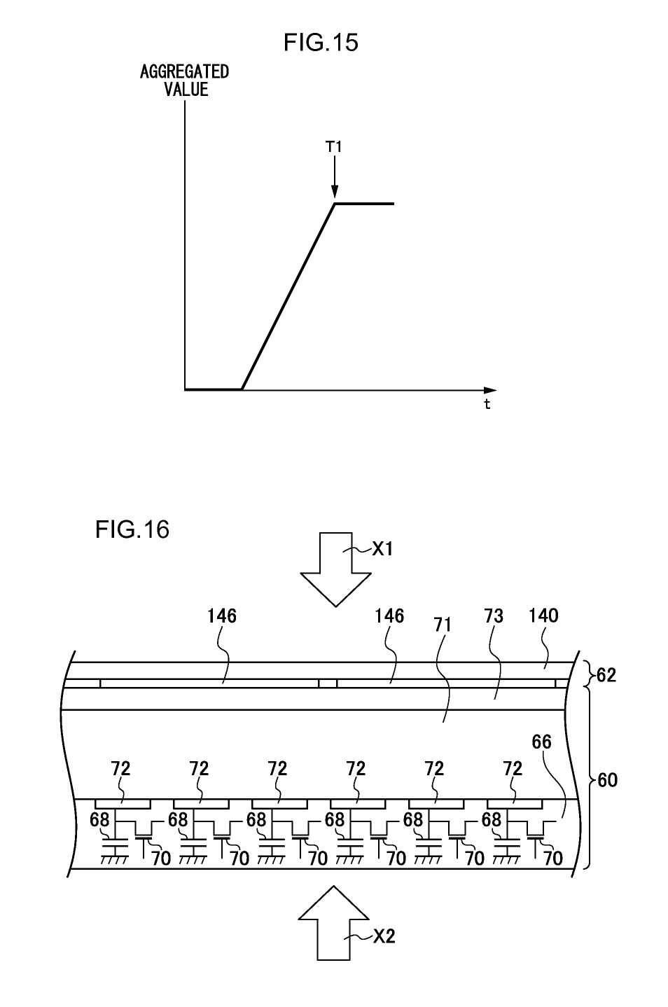

In a case in which digital data values of the sensor portions 146 are aggregated, the end of an irradiation may be detected when there is an inflection point at which the rate of increase of an aggregated value greatly decreases, as illustrated at time T1 in FIG. 15.

In the exemplary embodiment described above, a case is described in which the scintillator 148 is formed at the radiation detection section 62, but the present invention is not limited thus. For example, in a case in which the vapor deposition substrate 73 at which the scintillator 71 is formed is transparent to light, as shown in FIG. 16, the radiation detector 60 need not be provided with the scintillator 148 at the radiation detection section 62 but the scintillator 148 may be adheringly attached to a face at the opposite side of the radiation detector 60 from the side thereof at which the TFT substrate 66 is provided (i.e., the face at the side at which the scintillator 71 is provided), and the sensor portions 146 of the radiation detection section 62 may detect light from the scintillator 71. Thus, because the radiation detection section 62 is adhered to the scintillator 71, the scintillator 148 is unnecessary. Therefore, the radiation detection section 62 may be formed to be thinner. In such a case, the TFT substrate 66 is disposed so as to be at the irradiated surface 56 side in the housing 54, and the radiation at a time of imaging is incident from the lower side in FIG. 16 (the side of X2). The radiation detection section 62 may be disposed so as to be at the irradiated surface 56 side in the housing 54 and the radiation may be incident from the upper side in FIG. 16 (the side of X1). In a case in which the radiation is incident from the X2 side, because the radiation detection section 62 is provided at the face of the scintillator 71 at the opposite side thereof from the TFT substrate 66, the radiation X passes through the radiation detection section 62 after passing through the radiation detector 60. Therefore, effects on radiation images captured by the radiation detector 60 that are caused by the provision of the radiation detection section 62 may be prevented. In a case in which the radiation is incident from the X1 side, the radiation passes through the radiation detection section 62 and then reaches the scintillator 71. Therefore, it is preferable if the sensor portions 146 are formed with a photoelectric conversion film containing an organic photoelectric conversion material. Thus, in a case in which the sensor portion 146 is constituted to include an organic photoelectric conversion material, absorption of the radiation by the sensor portion 146 is very small. Therefore, effects on radiation images captured by the radiation detector 60 may be kept small.

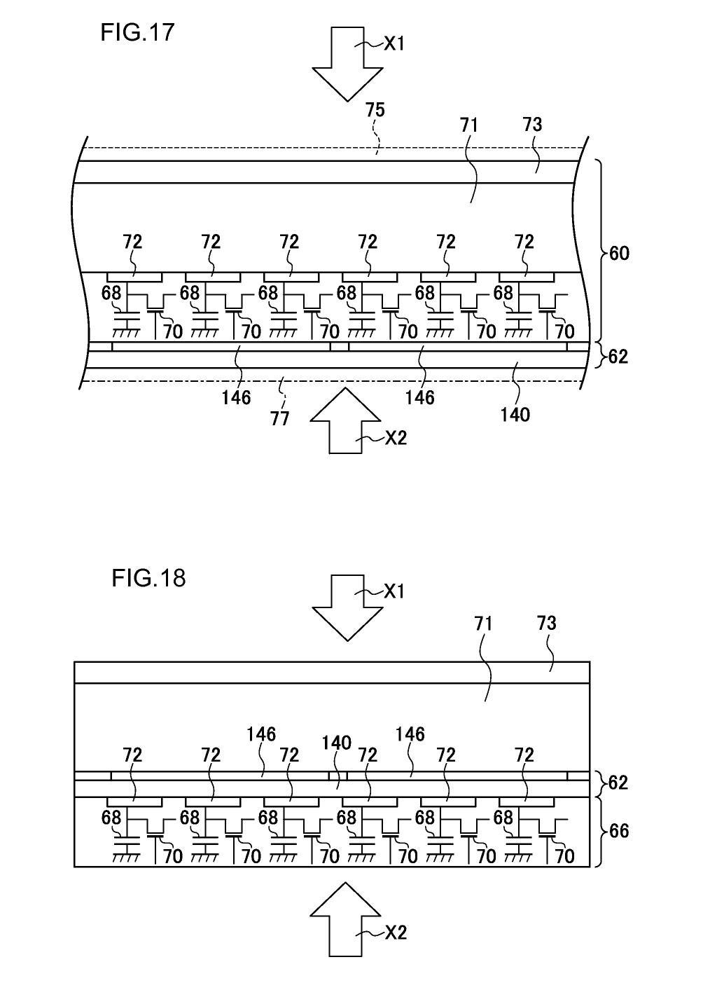

As a further example, in a case in which the TFT substrate 66 is transparent, as shown in FIG. 17, the radiation detection section 62 may be adhered to the face of the radiation detector 60 at the side thereof at which the TFT substrate 66 is disposed. In this case too, radiation may be incident from either of the upper side in FIG. 17 (the X1 side) and the lower side (the X2 side). However, in a case in which radiation is incident from the X2 side, the radiation passes through the radiation detection section 62 and then reaches the scintillator 71. Therefore, it is preferable if the sensor portions 146 are formed with a photoelectric conversion film containing an organic photoelectric conversion material. If the radiation detector 60 and radiation detection section 62 are layered as shown in FIG. 17, it is preferable to form a reflection film 75 that reflects light at the face of the scintillator 71 at the side at which the vapor deposition substrate 73 is disposed, as illustrated by the dashed line. A reflection film 77 that reflects light may also be formed at the face of the radiation detection section 62 at the opposite side thereof from the side at which the radiation detector 60 is disposed, as illustrated by the one-dot chain line. If the reflection film 75 and reflection film 77 are formed thus, light leaking toward the outside is reflected toward the TFT substrate 66, the radiation detection section 62 and the like. Therefore, sensitivity is improved.

Further, as shown in FIG. 18, the radiation detection section 62 may be disposed between the TFT substrate 66 of the radiation detection section 62 and the scintillator 71. In this case too, the radiation may be incident from either of the upper side in FIG. 18 (the X1 side) and the lower side (the X2 side). In this case, because a fall in sensitivity of the sensor portions 72 of the TFT substrate 66 is suppressed, the sensor portions 146 of the radiation detection section 62 may be formed to be thinner and/or the sensor portions 146 may be formed to be smaller than the areas of the sensor portions 72.

In the exemplary embodiment described above, a case is described in which the radiation detector 60 has an indirect conversion system in which radiation is temporarily converted to light, and the converted light is converted to electric charge at the sensor portions 72 and stored. However, the present invention is not limited thus. For example, the radiation detector 60 may have a direct conversion system that converts radiation to electric charges with a semiconductor layer of amorphous selenium or the like.

In the exemplary embodiment described above, a case is described in which the image quality of a radiation image generated from the radiation detector 60 is adjusted in accordance with a radiation image detected by the sensor portions 146 of the radiation detection section 62, but the present invention is not limited thus. For example, the electronic cassette 32 may send a radiation image detected by the sensor portions 146 of the radiation detection section 62 to the console 42 and the console 42 may display this radiation image at the display 100. Hence, blurring of the imaging subject, positioning and the like may be quickly checked from the displayed radiation image.

In the above descriptions, a case is described in which adjustment of a gain amount in accordance with a radiation image detected by the sensor portions 146 of the radiation detection section 62 and processing to detect for the start of an irradiation of radiation, the end of an irradiation of radiation, and irradiation amounts of radiation are carried out at the cassette control section 92 of the electronic cassette 32, but the present invention is not limited thus. For example, the cassette control section 92 may continuously send digital data inputted from the signal detection section 162 to the console 42, some of this processing may be carried out at the console 42, and processing results may be fed back to the electronic cassette 32 as necessary.

In the above exemplary embodiment, a case is described in which the present invention is applied to a radiation image capture device that images radiation images by detecting X-rays that are the radiation, but the present invention is not limited thus. For example, the radiation that is the target of detection may be, beside X-rays, any of visible light, ultraviolet rays, infrared rays, gamma rays, particle rays and the like.

The configuration described in the above exemplary embodiment is an example. It will be clear to those skilled in the art that unnecessary portions may be removed, new portions may be added, and connection states and the like may be altered within a scope not departing from the spirit of the present invention.

Furthermore, the flow of processing of each kind of program described in the above exemplary embodiment (see FIG. 11) is an example. It will be clear to those skilled in the art that unnecessary steps may be removed, new steps may be added, and processing sequences may be rearranged within a scope not departing from the spirit of the present invention.

The disclosures of Japanese Patent Application No. 2010-172792 are incorporated into the present specification by reference in their entirety.

All references, patent applications and technical specifications cited in the present specification are incorporated by reference into the present specification to the same extent as if the individual references, patent applications and technical specifications were specifically and individually recited as being incorporated by reference.

1. A radiation image capture device, comprising:
an imaging section in which pixels are plurally arranged two-dimensionally in an imaging region that captures a radiation image, each pixel including a first sensor portion that generates electrical charges when irradiated with radiation or with light converted from radiation, the imaging section outputting electrical charge accumulated at the pixels as an electrical signal;
a detection section that is provided so as to be layered over the imaging region of the imaging section and in which a second sensor portion is plurally provided, the second sensor portion being capable of detecting the radiation or the light converted from radiation; and
an irradiation amount detection section that detects an irradiation amount of radiation on the basis of a detection result from the second sensor portions of the detection section.

2. The radiation image capture device according to claim 1, wherein:
the imaging section includes a conversion layer that converts radiation to light, and the first sensor portion generates electrical charge when irradiated with the light converted by the conversion layer; and
the second sensor portion is configured to include an inorganic photoelectric conversion material, is disposed at a side of the imaging section at which a face on which the radiation is irradiated is disposed, and detects the light converted by the conversion layer.

3. The radiation image capture device according to claim 1, further comprising:
a generation section that includes an amplifier, a gain amount of the amplifier being alterable and the amplifier amplifying the electrical signal output from the pixels of the detection section, and the generation section generating image data representing a radiation image on the basis of the electrical signal amplified by the amplifier; and
an adjustment section that adjusts the gain amount of the amplifier on the basis of the radiation irradiation amount detected by the irradiation amount detection section.

4. The radiation image capture device according to claim 3, further comprising an identification section that identifies an imaging subject region of the imaging region at which an imaging subject is disposed,
wherein the adjustment section adjusts the gain amount, on the basis of a detection result from the second sensors of the detection section that corresponds with the imaging subject region identified by the identification section, such that a main density range of the imaging subject region in the radiation image generated by the generation section is within a predetermined suitable density range.

5. The radiation image capture device according to claim 3, wherein:
the generation section further includes an analog-to-digital converter that converts the electrical signal amplified by the amplifier to digital data with a predetermined number of bits; and
the adjustment section adjusts the gain amount such that the electrical signal amplified by the amplifier is within an input range that can be converted to digital data with a predetermined resolution at the analog-to-digital converter.

6. The radiation image capture device according to claim 3, wherein the irradiation amount detection section further detects, on the basis of a detection result from the second sensor portions of the detection section, at least one of a start of irradiation of radiation or an end of irradiation of radiation.

7. The radiation image capture device according to claim 3, wherein:
in a case of radioscopic imaging, the irradiation amount detection section detects, in an imaging period corresponding to a frame rate of the radioscopic imaging, an irradiation amount of radiation in the imaging period; and
the adjustment section adjusts the gain amount of the amplifier on the basis of the irradiation amount of radiation in the imaging period detected by the irradiation amount detection section.

8. The radiation image capture device according to claim 1, wherein the second sensor portions are disposed at least at a central portion and a peripheral portion of a region corresponding to the imaging region of the imaging section.

9. The radiation image capture device according to claim 1, wherein the second sensor portions are disposed in a matrix pattern in the imaging region of the imaging section.

10. The radiation image capture device according to claim 9, further comprising:
a simple image generation section that generates a simple radiation image from a detection result from the second sensor portions of the detection section; and
a display section that displays the simple radiation image generated by the simple image generation section.

11. A radiation image capture system comprising:
an imaging section in which pixels are plurally arranged two-dimensionally in an imaging region that captures a radiation image, each pixel including a first sensor portion that generates electrical charge when irradiated with radiation or with light converted from radiation, the imaging section outputting electrical charge accumulated at the pixels as an electrical signal; and
a detection section that is provided so as to be layered over the imaging region of the imaging section and in which a second sensor portion is plurally provided, the second sensor portion being capable of detecting the radiation or the light converted from radiation;
a generation section that includes an amplifier, a gain amount of the amplifier being alterable and the amplifier amplifying the electrical signal output from the pixels of the detection section, and the generation section generating image data representing a radiation image on the basis of the electrical signal amplified by the amplifier;
an irradiation amount detection section that detects an irradiation amount of radiation on the basis of a detection result from the second sensor portions of the detection section; and
an adjustment section that adjusts the gain amount of the amplifier on the basis of the radiation irradiation amount detected by the irradiation amount detection section.
